(19) United States
(12) Patent Application Publication
(10) Pub. No.: US 2013/0118045 A1
(43) Pub. Date: May 16, 2013

(54) Over-Sized Three-Dimensional Positionable Hand Structures

(71) Applicants: Joe M. Sample, Spokane, WA (US); Vincent J. De Felice, Spokane, WA (US)

(72) Inventors: Joe M. Sample, Spokane, WA (US); Vincent J. De Felice, Spokane, WA (US)

(21) Appl. No.: 13/385,591

(22) Filed: Aug. 31, 2011

Related U.S. Application Data
(63) Continuation-in-part of application No. 29/380,699, filed on Dec. 9, 2010.
Application No. 29/380,699 is a continuation-in-part of application No. 12/838,293, filed on Jul. 16, 2010, now Pat. No. 8,141,281.
Application No. 12/838,293 is a continuation-in-part of application No. 29/310,110, filed on Jul. 24, 2008.
Application No. 29/310,110 is a continuation-in-part of application No. 29/315,167, filed on Jun. 2, 2009, now Pat. No. D625653.
Application No. 29/315,167 is a continuation-in-part of application No. 29/315,170, filed on Jun. 2, 2009, now Pat. No. D622630.

(51) Int. Cl. G09F 21/02

(52) U.S. Cl. CPC G09F 21/02
USPC 40/538

(57) ABSTRACT

Disclosed herein are over-sized three-dimensional positionable hand structures that can be used to create various gestures.

### FIELD OF THE DISCLOSURE

The present disclosure relates to over-sized three-dimensional positionable hand structures that can be used to create various gestures.

### BACKGROUND OF THE DISCLOSURE

Over-sized foam hand cutouts have been made, generally with fingers closed into a fist except for the index finger which is raised to make a “number one” gesture. These foam hands have been used by, for example, spectators at sporting events. The “hand” has historically been provided as a static two-dimensional hand, that is, when viewed from the front or back it resembles a hand with the index finger raised, but from the side it does not look like a hand, but rather a flat piece of foam.

### BRIEF SUMMARY OF THE DISCLOSURE

Embodiments of the present disclosure provide over-sized three-dimensional positionable hand structures with one or more digits that can be used to create various gestures by a user. Because the structure is three-dimensional, it resembles a hand from all angles. Because the one or more digits can be positioned into various gestures and remain there for a period of time, the hand structure is not restricted to the static “number one” hand gesture. Particularly, one embodiment includes an over-sized three-dimensional hand structure with a base portion and one or more digits having sufficient flexibility to allow a user to position the one or more digits into a position and sufficient rigidity that the one or more digits retains the position after being positioned by the user for a period of time.

In another embodiment, the flexibility and rigidity are provided by an inner skeleton comprising a digit structure within the one or more digits.

In another embodiment, the three-dimensional hand structure is comprised of foam rubber. In some embodiments, the foam rubber is polyurethane foam rubber.

In another embodiment, the three-dimensional hand structure further comprises an opening in the base portion allowing access to a hollow portion of the hand structure. In another embodiment, the opening and hollow portion are sized to fit a human hand.

In another embodiment, the over-sized three-dimensional hand structure is attached to headgear.

In another embodiment, the base portion is attached to fabric.

In another embodiment, the over-sized three-dimensional hand structure resembles a human hand. In another embodiment, the over-sized three-dimensional hand structure resembles the paw, claw or pincer of a non-human animal. In another embodiment, the over-sized three-dimensional hand structure resembles the hand of a fanciful creature.

In another embodiment, the digit structure comprises wire, an alloy core, and/or a tube comprising one or more ball-and-socket-type joints configured for motion around a number of axes. In some embodiments the digit structure comprises a wire of ⅛ inch in diameter, with a plastic cap at each end of the wire.

In another embodiment, the period of time is until the user repositions the one or more digits. In another embodiment, the period of time is at least one hour.

### BRIEF DESCRIPTION OF THE DRAWINGS

FIGS. 1A and 1B depict perspective views of the standard over-sized hand cut-out making the “number one” gesture as is known in the art. FIG. 1A is a “front” view, and FIG. 1B is the cut-out as seen from the side.

FIGS. 2A-C depict perspective views of embodiments of an over-sized three-dimensional positionable hand structure as disclosed herein. FIG. 2A is a view of the back of the hand; FIG. 2B is a view of the front of the hand and FIG. 2C is a view of one side of the hand.

FIGS. 3A and 3B depict embodiments wherein digits of the hand structure are bent to form various gestures.

FIGS. 4A and 4B depict embodiments of an inner skeleton and digit structures of a hand structure as disclosed herein.

FIGS. 5A-C depict perspective views of embodiments of the present disclosure wherein the digit structure comprises one or more wires, plastic caps and a covering.

FIGS. 6A and 6B depict perspective views of embodiments of the present disclosure wherein the digit structure comprises a tube of ball-and-socket-type joints and a covering.

FIGS. 7A and 7B depict perspective views of the front view of an embodiment of the present disclosure wherein the hand structure is adapted to be worn by a user. FIG. 7C depicts a front view and cut-away to show an internal handle embodiment disclosed herein. FIG. 7D depicts a front view of an embodiment that includes draw strings to secure the hand around a user's wrist.

FIG. 8 depicts a front view of an embodiment that is attached to fabric to represent a sleeve.

FIG. 9A depicts a front view of an embodiment of the present disclosure wherein the hand is an animal claw. FIG. 9B depicts a side view of an embodiment wherein the hand is a pincer. FIG. 9C depicts a front view wherein the hand is one of a fanciful creature.

### DETAILED DESCRIPTION

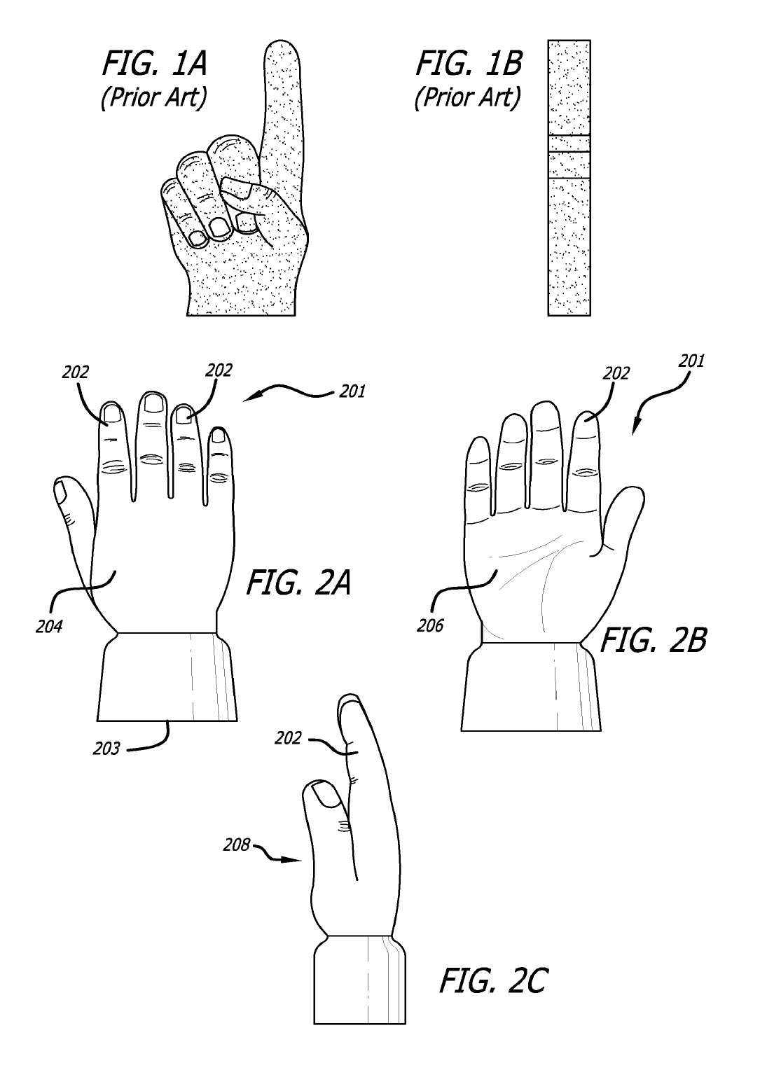

Over-sized foam or foam plastic hands have been made, usually of some material such as polyurethane open-cell foam, and generally with fingers closed into a fist except for the index finger which is raised so the hand makes a “number one” gesture. The “hand” has historically been provided as a static two-dimensional hand, that is, when viewed from the front or back it resembles a hand with the index finger raised, but from either side it does not look like a hand. The front and side views of such a hand are depicted in FIGS. 1A and 1B.

Embodiments of the present disclosure provide over-sized three-dimensional positionable hand structures with one or more digits that can be used to create various gestures. Because the structure is three-dimensional, it resembles a hand from all angles. Because the one or more digits can be positioned into various gestures by a user, it is not restricted to a static gesture such as the “number one” hand gesture, but instead can be changed into different gestures for different purposes.

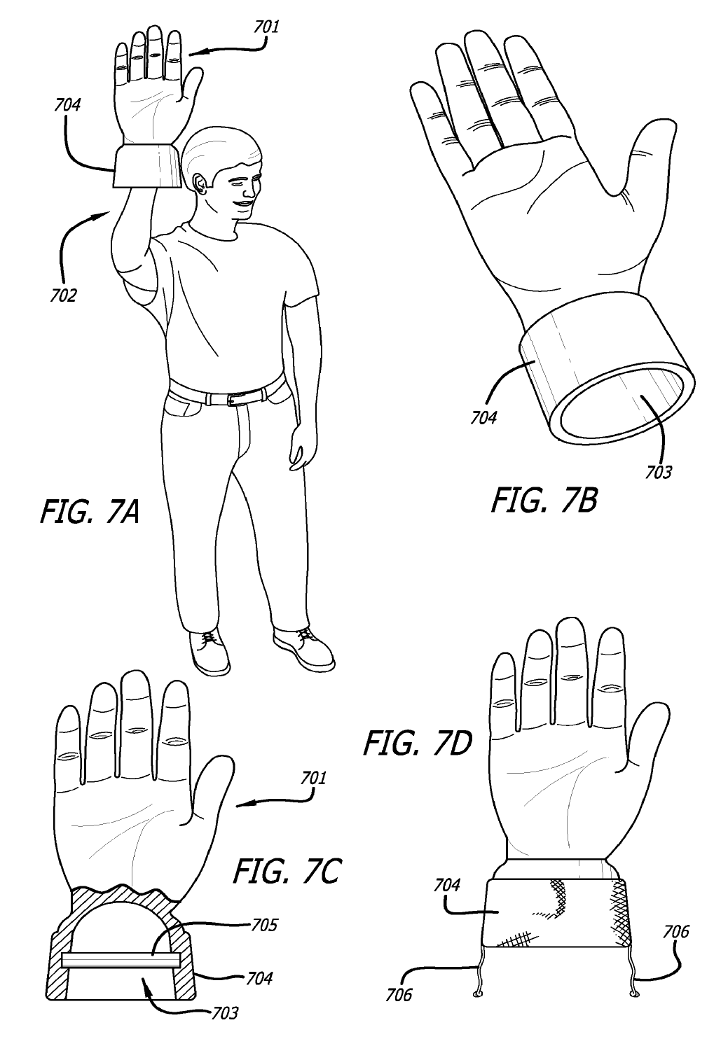

Embodiments of the over-sized three-dimensional positionable hand structures disclosed herein can be manufactured of any compliant material of a suitable weight and flexibility. Particular examples include, without limitation, foam (or foam rubber), foam plastic, polyurethane foam, polyurethane open-cell foam, thermoset foam, thermoplastic foam, visco-elastic polyurethane foam, closed or open cell foam, polystyrene foam, foam rubber latex, other foam materials, rubber, silicone rubber, etc. In some embodiments the hand structure can be formed in a single piece, for example from a single mold. In embodiments in which the hand structure comprises polyurethane foam, the outer form of the hand structure can be created by pouring a polyurethane mold by techniques known in the art. In other embodiments, separate parts of the hand structure can be made and then connected to form one hand structure by, for example but without limitation, heating, welding, adhering, sewing, stitching, or otherwise joining the parts. In embodiments where the hand structure is constructed by molding a single piece, the opening at the base of the hand structure (see, e.g., FIG. 7B) can be provided, for example, by using a mold extension, which creates the opening at the base of the hand structure upon release of the mold. In other embodiments, the hand structure can be manufactured of any sort of conventional padding material and covered with an outer coating. Certain embodiments can be similar to the way a conventional boxing glove comprises padding covered with and contained by a glove-shaped leather or other fabric outer coating.

FIGS. 2A-C depict perspective exterior views of one embodiment of an over-sized three-dimensional positionable hand structure 201 disclosed herein, with digits 202, demonstrating that the hand structure has a three-dimensional hand appearance when viewed from any angle. The base of the hand structure 203 as referred to herein represents generally where a wrist would attach to the hand as understood by principles of basic anatomy. FIG. 2A shows the back 204 of the hand structure 201, FIG. 2B the front or palm 206 of the hand structure 201, and FIG. 2C a side 208 of the hand structure 201.

“Over-sized” as used herein means grossly larger than any human hand. In some embodiments, the hand structure measures at least 12, 13, 14, 15, 16, 17, 18, 19, 20, 21, 22, 23, or 24 inches from the bottom of the base of the hand structure to the tip of the index finger or longest digit. In some embodiments the area of the palm measures at least 3×6 inches, or 3.5×6 inches, or 4×6 inches, or 3×6.5 inches, or 3.5×6.5 inches, or 4×6.5 inches, or 4.5×6.5 inches. In some embodiments, the area of index finger digit measures 7×1.25 inches, or 7.5×1.25 inches, or 8×1.25 inches, or 8.5×1.25 inches, or 7×1.5 inches, or 7.5×1.5 inches, or 8×1.5 inches, or 8.5×1.5 inches. In some embodiments the base measures at least 15, 16, 17, 18, 19, 20, 21, 22, 23, 24, 25, 26, 27, 28, 29, or 30 inches in circumference. In some embodiments, the base knuckles of the digits altogether measure at least 15, 16, 17, 18, 19, 20, 21, 22, 23, 24, 25, 26, 27, 28, 29, or 30 inches in circumference. In some embodiments, the middle knuckles of the digits altogether measure at least 15, 16, 17, 18, 19, 20, 21, 22, 23, 24, 25, 26, 27, 28, 29, or 30 inches in circumference. In some embodiments, the end knuckles of the digits altogether measure at least 15, 16, 17, 18, 19, 20, 21, 22, 23, 24, 25, 26, 27, 28, 29, or 30 inches in circumference. In some embodiments, the one or more digits individually measure at least 1, 2, 3, 4, 5, 6, 7, 8, 9 or 10 inches in circumference. In some embodiments, the hand structure is at least 2 times the size of an average adult human hand. In other embodiments, the hand structure is at least 1.5, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15 or 15.5 times the size of an average adult human hand.

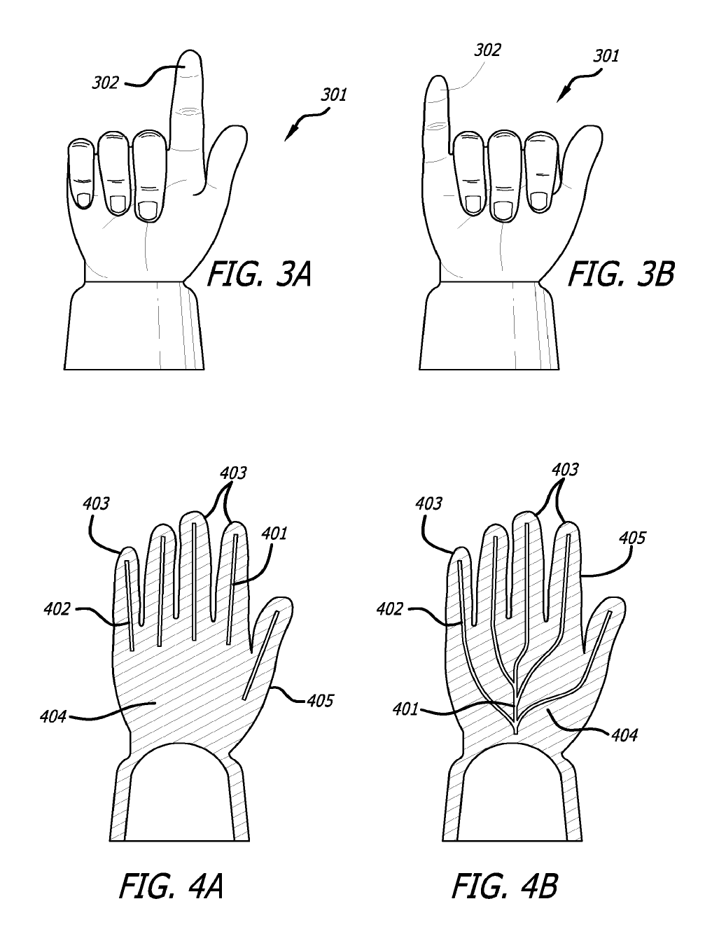

FIGS. 3A and 3B depict embodiments of the present disclosure showing how the digits 302 of the hand structure 301 can be positioned into different gestures, the digits retaining the gestures after being positioned for a period of time. The over-sized three-dimensional positionable hand structures disclosed herein can be manufactured to allow different periods of time that positioned gestures are maintained. For example, one period of time extends from when a user positions the one or more digits into one position, until the user re-positions the one or more digits into a different gesture. In other embodiments, the period of time can be a set time (for example, one to twenty-four hours and every increment in between) wherein when the time period has elapsed, the one or more digits revert to a default position. In other embodiments, the period of time can be a time range such that the digits retain a gesture, slowly reverting to a default position over time. The range of time can be over minutes, hours or days. As will be understood by those of ordinary skill in the art, these features can be created by manipulating the density of the materials used, the ability of the materials to hold shape memory, the tensile strength of the materials, the weight of various portions of the hand structure and/or through the use of internal mechanisms within the digits and/or elsewhere within the hand structure. As one example and without limitation, various thermoset foam plastic materials exhibit an ability to recover some time after bending or other deformation. As another example, polyurethane foam can be used of the type known in the art as “memory foam,” or visco-elastic polyurethane foam, or low-resilience polyurethane foam (LRPu), or “slow spring back foam,” the preceding terms all being synonymous as used herein. In some embodiments the memory foam is polyurethane formed by mixing a polycarbonate polyol with a polyisocyanate. In various embodiments of the disclosure in which memory foam is used, the memory foam is compressed when the digit is positioned by the user, then naturally expands from its compressed position to its original expanded position, over a period of time.

Some embodiments of the present disclosure adopt internal mechanisms to achieve positional stability of the digits. FIGS. 4A and 4B depict some embodiments of hand structures disclosed herein that adopt internal mechanisms to achieve positional stability. The depicted embodiment includes an inner skeleton 401 within the outer material 404 (such as, for example but without limitation, foam) of the hand structure which comprises a digit structure 402 within each digit 403. In the embodiment depicted in FIG. 4A, each digit structure 402 is separate within its digit 403 such that the inner skeleton 401 comprises five separate and unattached digit structures 402. In the embodiment depicted in FIG. 4B, the digit structures 402 are attached at the base to form one composite inner skeleton 401. Also shown in the embodiment of FIG. 4 is the optional covering 405 over the outer material of the hand structure.

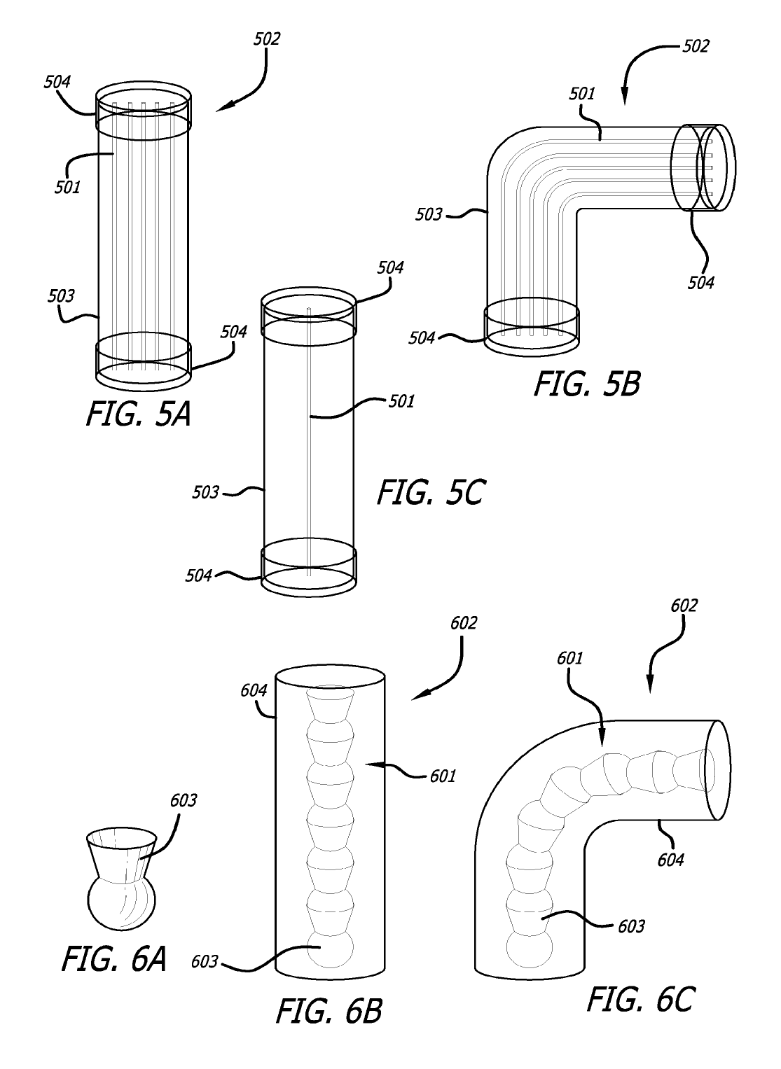

FIGS. 5A-C depict embodiments of the present disclosure wherein the digit structure 502 comprises one or more wires 501, the wires optionally surrounded by a flexible outer covering 503, and both ends of the wire optionally capped 504 with a material such as, for example, plastic. The optional cap can help prevent the wire from poking into or out of the foam of the hand structure. FIG. 5B demonstrates how the digit structure 502 can be bent into a position and the wires 501 within cause the digit structure 502 to retain the position. The digit structure can comprise a single wire or multiple wires. In constructing the hand structure, once could select single- or multiple-strand wire, or any other appropriate material, for the digit structure depending on the properties one wished to impart to the digit structure; for example, a single wire may hold its shape longer than multiple wires, whereas multiple wires may relax more quickly than a single wire. The wire can be any of a variety of types; for example but without limitation, copper wire, electrical wire, etc. The wire can be any of a variety of sizes and/or gauges (as measured, e.g., by the American wire gauge system) and/or diameters such as, for example but without limitation, in the range of 1 to 10 gauge, or 1, 2, 3, 4, 5, 6, 7, 8, 9 or 10 gauge, or in the range of 0.1 to 0.3 inch in diameter, or 0.29, 0.26, 0.23, 0.20, 0.18, 0.16, 0.14, 0.13, 0.11 or 0.10 inch in diameter.

FIGS. 6A-C depict embodiments of the present disclosure wherein the digit structure 602 comprises a tube 601 comprising multiple ball-and-socket-type joints 603 connected end to end, the tube optionally surrounded by a flexible outer covering 604. FIG. 6A depicts an embodiment of a single ball-and-socket-type joint member 603. FIG. 6C demonstrates how the digit structure 602 can be bent into a position and the tube 601 within can cause the digit structure 602 to retain the position.

FIGS. 7A-D depict embodiments of the present disclosure wherein the hand structure 701 is adapted to be worn by a user 702 on the user's hand by providing an opening 703 at the base 704 of the hand structure. The opening 703 provides access to a hollow portion within the hand structure sized to receive a human hand. These embodiments can adopt various features to facilitate the user's hand remaining in the hollow portion. As one example, FIG. 7C depicts an embodiment in which the hollow portion includes a handle 705 that the user could hold onto. As another example, FIG. 7D depicts an embodiment in which the opening comprises draw strings 706 to tighten the opening around a user's wrist or forearm. The interior surface of the hollow portion could form-fit around a user's hand, or the hand structure could comprise voids or pockets that could be expanded with air to compress the hollow portion around a user's hand.

FIG. 8 shows an embodiment of the disclosure wherein the hand structure 801 additionally includes a fabric or other material 802 that is attached to the base 803 of the hand structure, which fabric can represent, for example, a sleeve, and can be any of various lengths. By fabric is meant any of various fabrics or like materials that can be used for clothing or garments or to resemble clothing or garments such as, for example but without limitation, jersey, cotton, polyester, nylon, polypropylene, rayon, wool, blends, etc. The fabric can also be of stretchable or flexible material, such as polymer sheets, spandex reinforced fabrics or similar elastic fabrics. In some embodiments the fabric can be separate from the hand structure and can be attached in such a manner as to allow for removal, such that any of various “sleeves” or fabrics can be switched out and/or attached to the same hand structure, or any of various hand structures can be switched out and/or attached to the same “sleeve” or fabric. Attachment of fabric to the hand structure can be by attachment devices that allow for removal as are known in the art, such as for example but without limitation, zippers, hook-and-loop fasteners such as VELCRO® (Velcro Industries, BV, Manchester, N.H., USA), snaps, buttons, etc. In other embodiments the stretchable material of the fabric can permit attachment of the fabric to the base without additional fasteners. In other embodiments the fabric can be permanently attached to the hand structure such as, for example, by sewing the fabric to the hand structure material. In various embodiments of the present disclosure the fabric is decorated, such as for example with color, lettering, words, phrases, logos, ornamentation, or any combination thereof.

In some embodiments the hand structure can rest upon its base in the upright position without any other support. In these embodiments the base can be configured to support the entire hand structure. The base, therefore, has sufficient stiffness and weight and is sufficiently broad to support the weight of the hand structure without allowing the hand structure to fall over within five to thirty seconds of placing the hand structure on its base on a level surface.

In other embodiments, the hand structure can be adapted to be worn by a user on the user's head. In various embodiments, the hand structure can be attached to a hat, a cap, or any other type of headgear to fasten the structure to the head. In other embodiments, attachment to the head can be by a strap, such as a chin strap of string or elastic material, or attachment can be by securing the hand structure to the ears.

In other embodiments, the hand structure can be adapted to fit onto a stand such that it sits upright and freely without being held by or attached to a user. In other embodiments, the hand structure can be adapted to be attached to a stick, a handle, or any other sort of structure which the user can hold, in which embodiments the hand structure is not attached to or fitted onto the user.

The outer surface of the hand structure can be provided in any color. In particular embodiments, the hand structures are provided in one or more colors of a sports team. The outer surface can be further decorated with, for example and without limitation, team names, logos and depictions of mascots.

In certain embodiments, the outer surface of the hand structure is co-extensive with the material that forms the body of the hand structure—that is, there is no separate outer coating. Other embodiments can include an outer coating. For example, the outer surface can include a separate exterior layer formed of, without limitation, leather, vinyl, rubber, etc., and/or any other material that is commonly used in upholstery. In particular embodiments, whether there is a separate outer coating or not, the outer surface can resemble skin.

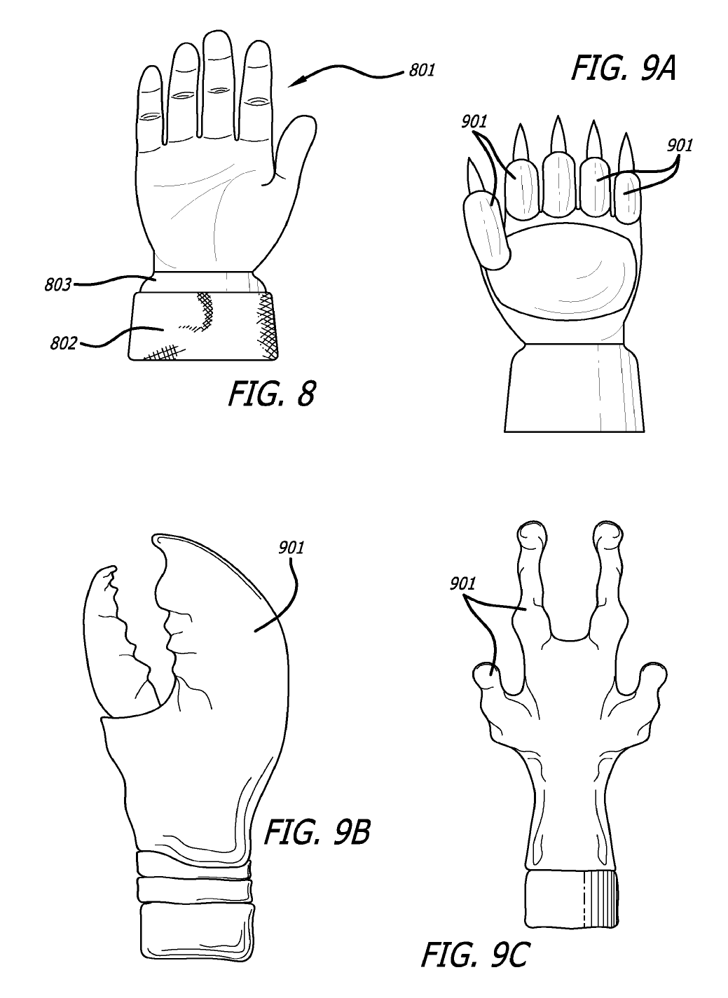

The term “hand” as used herein includes representations of a human hand but is not so limited. For example, “hand” can also include any human or non-human appendage that exists at the end of the respective human or non-human animal's arm or arm-like appendage, such as for example but without limitation, a foot, a paw, a claw, a pincer, etc. “Hand” as used herein can also mean an artificial or machine appendage such as, for example but without limitation, a hand or clutching device of a robot or other machine or can be that of fanciful creatures such as, and without limitation, aliens, bigfoot or the SMURFS® (Studio Peyo, Geneva, Switzerland). The term “digit” as used herein thus includes representations of a human digit such as a finger or toe, but also includes a “digit” of a non-human appendage such as of a claw, a paw, a pincer, etc., or a “digit” of an artificial machine appendage or fanciful creature. FIGS. 9A-C depict embodiments of the present disclosure wherein the “hand” and “digits” relate to non-human hands. FIG. 9A depicts one embodiment wherein the “hand” is an animal claw and the “digits” 901 are the individual digits of the overall claw. FIG. 9B depicts another embodiment, wherein the “hand” is pincer such as is found on a lobster. FIG. 9C depicts another embodiment, wherein the “hand” is that of a fanciful creature such as an alien creature.

It should also be obvious to those with skill in the art that the digit structure can comprise any material having sufficient flexibility to allow the user to position the digit into a plurality of different gestures, and having sufficient rigidity that the digit retains its position for a period of time after being positioned by the user. Such material can comprise, for example but without limitation, a wire such as copper wire or electrical wire, an alloy core such as a carbon steel alloy core, a tube or cylinder comprising one or more ball-and-socket or spheroidal-type joints configured for motion around a number of axes, and so on. See, e.g., FIGS. 5 and 6.

The foregoing disclosure and description of the invention is illustrative and explanatory thereof, and various changes in the size, shape, and materials, as well as in the details of illustrative construction and assembly, may be made without departing from the spirit of the invention.

Unless otherwise indicated, all numbers expressing quantities of ingredients, properties such as molecular weight, reaction conditions, and so forth used in the specification and claims are to be understood as being modified in all instances by the term “about.”

Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that any numerical ranges and/or parameters setting forth the broad scope of the invention are approximations, any numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. An over-sized three-dimensional hand structure with a base portion and one or more digits having sufficient flexibility to allow a user to position the one or more digits into a position and sufficient rigidity that the one or more digits retains the position after being positioned by the user for a period of time.

2. An over-sized three-dimensional hand structure of claim 1 wherein the flexibility and rigidity are provided by an inner skeleton comprising a digit structure within the one or more digits.

3. An over-sized three-dimensional hand structure of claim 1 comprising foam rubber.

4. An over-sized three-dimensional hand structure of claim 3 wherein the foam rubber comprises polyurethane foam rubber.

5. An over-sized three-dimensional hand structure of claim 1 further comprising an opening in the base portion allowing access to a hollow portion of the hand structure.

6. An over-sized three-dimensional hand structure of claim 5 wherein the opening and hollow portion are sized to fit a human hand.

7. An over-sized three-dimensional hand structure of claim 1 wherein the structure is attached to headgear.

8. An over-sized three-dimensional hand structure of claim 1 wherein the base portion is attached to fabric.

9. An over-sized three-dimensional hand structure of claim 1 wherein the hand structure resembles a human hand.

10. An over-sized three-dimensional hand structure of claim 1 wherein the hand shape resembles the paw, claw or pincer of a non-human animal.

11. An over-sized three-dimensional hand structure of claim 1 wherein the hand structure resembles the hand of a fanciful creature.

12. An over-sized three-dimensional hand structure of claim 2 wherein the digit structure comprises wire, an alloy core, and/or a tube comprising one or more ball-and-socket-type joints configured for motion around a number of axes.

13. An over-sized three-dimensional hand structure of claim 12 wherein the digit structure comprises a single wire that has substantially the same stiffness as a 5-gauge single-strand copper wire.

14. An over-sized three-dimensional hand structure of claim 12, wherein the digit structure comprises a tube comprising one or more ball-and-socket-type joints configured for motion around a number of axes.

15. An over-sized three-dimensional hand structure of claim 1 wherein the period of time is until the user repositions the one or more digits.

16. An over-sized three-dimensional hand structure of claim 1 wherein the period of time is at least one hour.

17. An over-sized three-dimensional hand structure of claim 1 wherein the hand structure can rest upon the base in the upright position without any other support.

18. An over-sized three-dimensional hand structure of claim 12 wherein the digit structure comprises a single wire with a diameter in the range of 0.08 to 0.18 inch.

19. An over-sized three-dimensional hand structure of claim 13 wherein the single wire is capped with a plastic cap at each end.

20. An over-sized three-dimensional hand structure of claim 18 wherein the single wire is capped with a plastic cap at each end.
